(19) United States
(12) Patent Application Publication
(10) Pub. No.: US 2023/0126190 A1
(43) Pub. Date: Apr. 27, 2023

(54) COMPUTER SYSTEM AND METHOD FOR BROKERAGE INCENTIVE PROGRAM

(71) Applicant: Wells Fargo Bank, N.A., San Francisco, CA (US)

(72) Inventors: Olaronke Akintolayo Faleti, St. Louis, MO (US); Carl McQueen, St. Louis, MO (US); Cory Joseph Wilson, St. Louis, MO (US); Zachary David Tangeman, St. Louis, MO (US)

(21) Appl. No.: 14/587,114

(22) Filed: Dec. 31, 2014

(51) Int. Cl. G06Q 40/00

(52) U.S. Cl. CPC G06Q 40/00

(57) ABSTRACT

A computer system and computer-based method for use with a brokerage incentive program comprising linking by a computer in a computer network a debt vehicle having an outstanding balance to a brokerage account, calculating by a brokerage incentive computer engine a return generated by at least one investment product in the brokerage account over a predetermined period of time, determining by the brokerage incentive computer engine a monetary amount equal to at least a portion of the calculated return generated, and automatically applying the monetary amount to the outstanding balance of the linked debt vehicle.

### FIELD OF THE INVENTION

The present invention relates to a computer system and method for administering a brokerage incentive program.

### BACKGROUND OF THE INVENTION

Incentive programs are very popular across numerous industries including the retail and airline industries. However, these existing incentive programs typically require the consumer to make a new purchase in order to receive a benefit. These incentive programs are typically not performance based.

However, there has not been a computer-implemented incentive program that does not require the consumer to make a new purchase and assists a consumer pay down his/her debts while managing and investing in an investment portfolio. Thus, there is a need for a program that is performance based and that helps an investor pay down debt.

There is also a desire to provide an investor other product offerings within a bank or other financial institution in association with an incentive program.

### SUMMARY OF THE INVENTION

The present invention relates to a computer system and method for administering a brokerage incentive program. The brokerage incentive program of the present invention is performance based by virtue of being based on the performance of the brokerage account over a predetermined period of time. The incentive program of the present invention enables an investor the ability to regularly invest in an investment portfolio, pay down his/her debts, and gain streamlined access to full suite of banking products including, but not limited to, consumer debt products, investment products and demand products in addition to having financial management advice. Thus, the performance-based incentive program of the present invention may be combined with other bank and investment products.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a diagram illustrating the environment in which the computer system and method of the present invention operates.

FIG. 2 is a flow chart illustrating the steps of the computer-implemented method.

FIG. 3 illustrates an example of a pop-up box viewable on a computer screen or other device of a user.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, which is contemplated to be adaptable across a wide range of industries. The following description is provided herein solely by way of example for purposes of providing an enabling disclosure of the invention, but does not limit the scope or substance of the invention.

The present invention relates to a computer system and method for administering an incentive program, more particularly a brokerage incentive program by which an investor may earn a monetary amount as a rebate in the form of a payment toward an outstanding debt vehicle. The debt vehicle may be a loan, credit account, or other debt vehicle. For example, the brokerage incentive program of the present invention may be used to reduce the overall cost of the installment loans. A payment may be applied toward an outstanding loan principal or to an outstanding loan balance to reduce loan principal and the overall cost of the loan. Examples of loans include, but are not limited to a mortgage, student loan, personal lines of credit, credit cards and any current or new/future consumer credit products where the consumer makes a payment to a funding institution as well as a reinvestment into another type of investment account, for example, 529 plans, and other investment accounts. A payment applied toward an outstanding loan balance to reduce the overall cost of the installment loan can be used, for example, for a credit card or other consumer lending products.

The term “brokerage account,” as used herein, generally refers to a financial account. A brokerage account may contain funds and/or securities that are deposited with a broker or other financial institution by a customer. For example, a brokerage account may be used by a person to trade or invest in equities.

The term “investment product,” as used herein, generally refers to a financial product or other item of value purchased with an expectation of earning a favorable future return. Examples of investment products may include, but are not limited to, securities, mutual funds, annuities, insurance, managed portfolios, limited partnerships, real estate investment trusts, and other direct investments, 401k, IRA, 529, plus any current or future products where individuals invest funds over a period of time with the expectation of a return based on market performance.

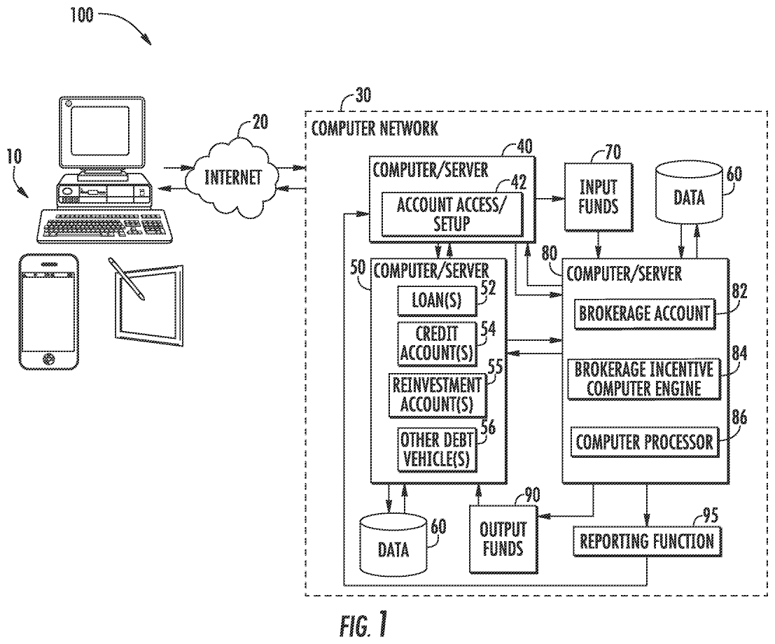

Referring to the figures, FIG. 1 is a diagram illustrating an environment 100 in which the computer system and computer-implemented method of the present invention operates. As shown in FIG. 1, a user (not shown) uses a computer-based device 10 to access, via the interne 20, a computer/server 40 in a computer network 30. The term “user,” as used herein, generally refers to an investor or potential investor, financial advisor or other third party acting on behalf of an investor or potential investor. An example of a computer-based device includes, but is not limited to, a computer, a mobile phone, a personal digital assistant, tablet, or other device having the capability to communicate over a computer network. The computer network 30 preferably comprises a special computer system configured for a financial institution. Among the reasons that the computer system of the present invention is unique is that it comprises a custom designed financial services platform comprising a financial advisory firm/brokerage house computer or server configured in a manner such that the investor and the credit line of the investor can be reduced due to the association with and payment received from the brokerage house computer/server.

In another aspect of the invention, the computer system has the ability to have a one to many relationship by which a consumer is presented a menu option of current debt lines (for example, using an aggregator service) and the consumer has the ability to direct where the incentive is to be applied. The computer system is special in that it is smart enough to give recommendations on which debt to apply first. The consumer is the decision maker on where the incentive funds are directed. For example, a consumer could choose to apply 100% of an incentive to a mortgage loan or break up the percentages between other installment loans.

A method of the present invention comprises presenting by a computer in a computer network to a computer-based device a menu option of current debt lines, providing a computer-generated recommendation to the computer-based device as to which debt line to apply a monetary amount equal to at least a portion of a calculated return generated by at least one investment product in a brokerage account over a predetermined period of time, receiving instructions from the computer-based device as to which debt line selected to apply the incentive, and applying the monetary amount to the selected debt line.

The computer/server 40 communicates with one or more computers/servers in the computer network 30 such as computer/server 50 and computer/server 80. Computer/server 50 comprises data and/or account information associated with a loan(s) 52, credit account(s) 54, reinvestment account 55, or other debt vehicle 56 of the user. The computer/server 50 may communicate with one or more databases 60 that store data and information. Computer/server 80 comprises a brokerage account 82, a brokerage incentive computer engine 84, and a computer processor 86 used in conjunction with the brokerage incentive computer engine 84. It is contemplated and within the scope of the present invention that one or more of these components of a respective computer/server can be present on one or more computer/servers such that there are numerous configurations within the computer network. For example, the brokerage account 82 may be housed on the same or a different computer/server than the brokerage incentive computer engine 84 and computer processor 86. Computer/server 80 may also communicate with one or more databases shown as database 60 in FIG. 1. An optional report generating and reporting function 95 is shown for purposes of generating reports and reporting information and data such as to send to computer/server 40 and to be accessible to the user.

A user may access a financial account such as a brokerage account through the computer/server 40. It is possible that once a user accesses the financial account, the user may choose to fund the account by transfer of funds to the account. For example, in the instance that the user wants to fund brokerage account 82, the user may transfer funds to the brokerage account which is shown as input funds 70 on FIG. 1. As is also shown in FIG. 1, the transfer of funds may also be initiated by computer/server 80 for use by computer/server 50 to pay down debt vehicles such as loan(s) 52, credit account(s) 54, and other debt vehicle(s) 56.

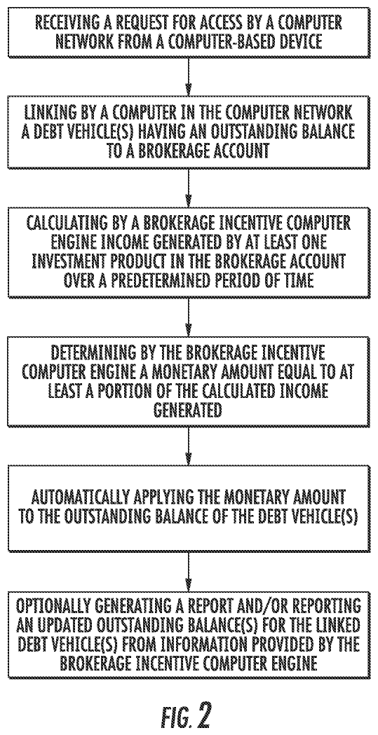

Referring to the flowchart in FIG. 2, in accordance with aspects of the method of the present invention, the computer network 30 receives a request for access from the computer-based device 10. The computer/server 40 may provide access for the user to an existing financial account or may provide the user with access 42 to setup a financial account. A user who enrolls and participates in the brokerage incentive program may select electronically, for example from the computer-based device, to which debt vehicle it wishes any payment to be automatically applied. If the user selects more than one debt vehicle, the user may also elect the percentage of any payment that is to be applied to the respective debt vehicles. Otherwise, the program may default to certain percentages. Using the computer-based device, a user may add or delete debt vehicles to be included in the brokerage incentive program. It is within the scope of the invention that the debt vehicle(s) may be related or unrelated to the financial institution that operates or is affiliated with the computer network 30.

One of the computers in the computer network has the functionality to link a debt vehicle having an outstanding balance of the user to a brokerage account of the user. FIG. 1 illustrates one possible configuration in which computer/server 40 links or otherwise associates a debt vehicle of the user accessed on computer/server 50 to a brokerage account 82 of the user accessed on computer/server 80.

The brokerage incentive computer engine 84 is comprised of computer hardware, computer software, or a combination thereof. Among the features of the brokerage incentive computer engine 84 is that it calculates or measures income generated by at least one investment product in the brokerage account 82 over a predetermined period of time.

The incentive computer engine 84 has the flexibility to leverage other banking products including those discussed herein and to bring over debt and to make investments.

The brokerage incentive computer engine 84 further determines a monetary amount equal to at least a portion of the calculated return generated. Brokerage account returns are calculated using a return calculation system. The incentive is to provide an additional return in the form of income from a portion of the return. The calculation preferably occurs on a quarterly basis to match the quarterly billing cycle of many fee based products.

As shown in FIG. 1, the monetary amount is automatically applied to the outstanding balance of the linked debt vehicle as illustrated by output funds 90. The monetary amount is applied without requiring intervention of the user.

This same method may also be used to automatically apply the monetary amount to a linked reinvestment account or to a combination of a linked reinvestment account and an outstanding balance of a linked debt vehicle.

The computer network 30 further comprises an optional reporting function 95. The reporting function 95 may be used to generate a report and/or to report an updated outstanding balance(s) for the linked debt vehicle from the information provided by the brokerage incentive computer engine 84.

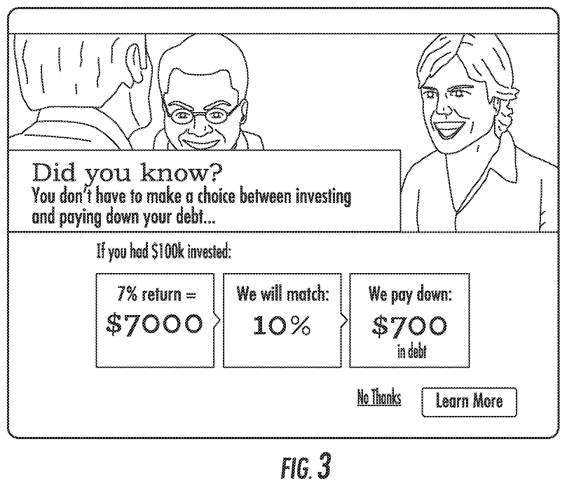

FIG. 3 illustrates an example of a pop-up box viewable on a computer screen or other device of a user.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A computer-implemented method for use with a brokerage incentive program, the method comprising:
electronically linking by a computer configured for a financial institution in a computer network a brokerage account to a reinvestment account, to a debt vehicle unrelated to the financial institution having an outstanding balance, or to a combination thereof, wherein the computer is communicatively connected to a brokerage incentive computer engine using a custom-designed financial services platform server;
calculating by the brokerage incentive computer engine a return generated by at least one investment product in the brokerage account over a predetermined period of time;
determining by the brokerage incentive computer engine a monetary amount equal to at least a portion of the calculated return generated, wherein the monetary amount is a matching incentive from the financial institution that is distinct from existing funds of the brokerage account and is calculated based on a percentage of the calculated return;
generating by the brokerage incentive computer engine a recommendation for application of the monetary amount;
displaying by the brokerage incentive computer engine the recommendation on a first screen of a graphical user interface (GUI) of a computer-based device;
requesting by the brokerage incentive computer engine an election of percentages of the monetary amount to be applied to the linked debt vehicle, including providing a selectable menu on a second screen of the GUI;
receiving by the brokerage incentive computer engine the election of percentages based on an input from the selectable menu on the second screen by a user of the computer-based device;
providing by the brokerage incentive computer engine an assignment of percentages of the monetary amount to be applied based on the input by the user;
automatically applying the monetary amount in a form of a rebate to the linked reinvestment account, to the outstanding balance of the linked debt vehicle, or to a combination thereof using the assigned percentages, wherein the computer is accessed over the internet by the computer-based device, and wherein automatically applying the monetary amount to the outstanding balance of the linked debt vehicle includes automatically making a payment directed to reduce an outstanding loan principal associated with the linked debt vehicle upon receipt of the input from the second screen;
automatically generating a report with an update to an amount of the outstanding balance of the linked debt vehicle after the monetary amount is applied;
electronically delivering the report to the user of the computer-based device over the computer network;
automatically generating a pop-up box viewable on a third screen of the graphical user interface (GUI) of the computer-based device, the pop-up box configured to show a potential calculated return and monetary amount based on a hypothetical amount of existing funds;
providing an interactive section of the pop-up box including a plurality of user-selectable portions on the third screen; and
upon receiving input from the user including a selection of one of the plurality of user-selectable portions of the third screen, providing the user with additional information regarding the matching incentive on a fourth screen of the GUI using the custom-designed financial services platform server.

2. The method according to claim 1, wherein the debt vehicle is a loan, a credit account, other debt vehicle, or a combination thereof.

3. (canceled)

4. The method according to claim 1, further comprising receiving a request for access by a computer network from the computer-based device.

5. The method according to claim 1, wherein the brokerage account is a new brokerage account or an existing brokerage account.

6. The method according to claim 4, wherein access is provided for a new account set-up to a user.

7. The method according to claim 1, further comprising transferring monetary funds into the brokerage account.

8. The method according to claim 1, further comprising generating a report.

9. The method according to claim 8, wherein the report comprises an updated outstanding balance for the linked debt vehicle.

10. The method according to claim 1, further comprising reporting information, data, or a combination thereof to the computer.

11. The method according to claim 1, wherein the monetary amount is automatically applied without intervention of a user.

12. A computer-implemented method for use with a brokerage incentive program, the method comprising:
presenting by a computer configured for a financial institution in a computer network to a computer-based device a menu option of current debt lines, wherein the computer is communicatively connected to a brokerage incentive computer engine using a custom-designed financial services platform server;
providing a computer-generated recommendation to a first screen of a graphical user interface (GUI) of the computer-based device as to which debt line to apply a monetary amount equal to at least a portion of a calculated return generated by at least one investment product in a brokerage account over a predetermined period of time, wherein the monetary amount is a matching incentive from the financial institution that is distinct from existing funds of the brokerage account and is calculated based on a percentage of the calculated return;
providing a selectable menu on a second screen of the GUI;
receiving instructions from the computer-based device as to which debt line selected to apply the monetary amount;
automatically applying the monetary amount in a form of a rebate to the selected debt line, wherein automatically applying the monetary amount includes automatically making a payment upon receipt of an input from the second screen;
automatically generating a report with an update to an amount of an outstanding balance of a linked debt vehicle after the monetary amount is applied;
electronically delivering the report to a user of the computer-based device over the computer network;
automatically generating a pop-up box viewable on a third screen of a graphical user interface (GUI) of the computer-based device, the pop-up box configured to show a potential calculated return and monetary amount based on a hypothetical amount of existing funds;
providing an interactive section of the pop-up box including a plurality of user-selectable portions on the third screen; and
upon receiving input from the user including a selection of one of the plurality of user-selectable portions of the third screen, providing the user with additional information regarding the matching incentive on a fourth screen of the GUI using the custom-designed financial services platform server.

13. A computer system for use with a brokerage incentive program, the computer system comprising:
a computer configured for a financial institution in a computer network electronically linking a brokerage account to a reinvestment account, to a debt vehicle unrelated to the financial institution having an outstanding balance, or to a combination thereof, wherein the computer is communicatively connected to a brokerage incentive computer engine using a custom-designed financial services platform server;
a brokerage incentive computer engine for calculating a return generated by at least one investment product in the brokerage account over a predetermined period of time and for determining a monetary amount equal to at least a portion of the calculated return generated, wherein the monetary amount is a matching incentive from the financial institution that is distinct from existing funds of the brokerage account and is calculated based on a percentage of the calculated return, wherein the brokerage incentive computer engine is configured to generate a recommendation for application of the monetary amount, display the recommendation on a first screen of a graphical user interface (GUI) of a computer-based device, request an election of percentages of the monetary amount to be applied to the linked debt vehicle on a second screen of the GUI, and provide an assignment of percentages of the monetary amount to be applied based on predetermined default percentages;
a reinvestment account, a debt vehicle having an outstanding balance, or a combination thereof using the assigned percentages, linked by the computer and to which the monetary amount is applied in a form of a rebate upon receipt of input from the second screen, wherein the computer is communicatively connected over the internet to the computer-based device; and
wherein the brokerage incentive computer engine is configured to automatically generate a report with an update to an amount of the outstanding balance of the linked debt vehicle after the monetary amount is applied, electronically deliver the report to a user of the computer-based device over the computer network, automatically generate a pop-up box viewable on a third screen of the graphical user interface (GUI) of the computer-based device, the pop-up box configured to show a potential calculated return and monetary amount based on a hypothetical amount of existing funds, provide an interactive section of the pop-up box including a plurality of user-selectable portions on the third screen, and upon receiving input from the user including a selection of one of the plurality of user-selectable portions of the third screen, provide the user with additional information regarding the matching incentive on a fourth screen of the GUI using the custom-designed financial services platform server.

14. (canceled)

15. The computer system according to claim 13, wherein the brokerage account is a new brokerage account or an existing brokerage account.

16. The computer system according to claim 13, further comprising computer access to set-up a new brokerage account.

17. The computer system according to claim 13, further comprising a reporting function for a generation of a report.

18. The computer system according to claim 17, wherein the report comprises an updated outstanding balance for the linked debt vehicle.

19. The computer system according to claim 13, wherein the monetary amount automatically applied without intervention of a user.

20. The computer system according to claim 13, wherein the debt vehicle is a loan, a credit account, other debt vehicle, or a combination thereof.

21. The computer-implemented method according to claim 1, wherein the pop-up box is configured to provide a user with information related to calculation of the monetary amount.

22. The computer system according to claim 13, wherein the pop-up box is configured to provide a user with information related to calculation of the monetary amount.
